(19) United States
(12) Patent Application Publication
(10) Pub. No.: US 2015/0140294 A1
(43) Pub. Date: May 21, 2015

(54) Preformed Thermoplastic Pavement Marking and Method for High Skid Resistance with Maintained High Retroreflectivity

(71) Applicant: Flint Trading, Inc., Thomasville, NC (US)

(72) Inventors: Simon Yakopson, Hickory, NC (US); Robert W. Greer, Lexington, NC (US)

(21) Appl. No.: 14/506,248

(22) Filed: Oct. 3, 2014

Related U.S. Application Data
(63) Continuation-in-part of application No. 12/592,458, filed on Nov. 25, 2009.
Application No. 12/592,458 is a continuation of application No. 10/816,635, filed on Apr. 2, 2004, now Pat. No. 7,645,503.

(30) Foreign Application Priority Data
Nov. 24, 2010 (US) PCT/US10/57955

(51) Int. Cl. E01F 9/04; C09J 177/08; C09J 131/04

(52) U.S. Cl. CPC E01F 9/042; C09J 131/04; C09J 177/08; E01F 9/044; C09J 2201/61
USPC 428/206; 523/172; 156/60; 156/308.2

(57) ABSTRACT

The disclosure describes preformed thermoplastic pavement marking material composition comprising an intermix and drop-on combination of glass beads and long term skid resistance aggregate provided in the necessary proportions to achieve high skid resistance of Class S5 while maintaining high retroreflectivity of Class R5 using non-clustered regular glass beads per standard IS EN 1436. More specifically the composition particularly pertains to markers such as lines, legends, arrows, indicia, and decorative markings including pavement marking patterns utilizing thermoplastic sheeting which utilize an adhesive (sprayable or otherwise) to maintain the integrity of the pattern prior to and during its application to a substrate.

### PRIORITY

The present application is a continuation-in-part and claims priority under 35 U.S.C. §120 from U.S. patent application Ser. No. 12/592,458, entitled “Preformed Thermoplastic Pavement Marking and Method Utilizing Large Aggregate for Improved Long Term Skid Resistance and Reduced Tire Tracking”, filed Nov. 25, 2009 which is a continuation of Ser. No. 10/816,635 entitled, “Pavement Marking Pattern and Method”, filed 2 Apr. 2004 and granted as U.S. Pat. No. 7,645,503 on Jan. 12, 2010. In addition this application hereby expressly incorporates by reference, in its entirety, all applications specified above.

### FIELD OF THE INVENTION

The disclosure herein pertains to preformed thermoplastic pavement marking materials comprising an intermix and drop-on combination of glass beads and anti-skid aggregate of selected size and/or size ratio, where the glass beads have an average diameter within the range of 1.0 to 1.4 mm and aggregate particles having an average size of 70% to 120% of the glass bead diameter, provided in specified proportions to achieve high skid resistance of Class S5 while maintaining high retroreflectivity Class of R5 using non-clustered regular glass beads per standard IS EN 1436, and particularly pertains to such markers as lines, legends, arrows, indicia, and decorative marking including pavement marking patterns utilizing thermoplastic sheeting which utilize an adhesive (sprayable or otherwise) to maintain the integrity of the pattern prior to its application to a substrate.

### BACKGROUND OF THE INVENTION

Traffic markings convey information to drivers and pedestrians by providing exposed visible, reflective, colored and/or tactile surfaces that serve as indicia. In the past, such a function was typically accomplished by painting a traffic surface. Modern marking materials offer significant advantages over paint such as dramatically increased visibility and/or reflectance, improved durability, and temporary removable marking options. Examples of modern pavement marking materials are thermoplastic, pavement marking sheet materials, tapes and raised pavement markers.

Preformed and hot applied thermoplastic materials used as pavement markings or for other indicia possess many advantages compared to paints and other less durable markings. These materials can be used for years and are capable of possessing high reflective properties with a retro-reflective luminance (RL) exceeding 500 mcd/m²/lx. However, pavement marking materials of a high RL typically have low skid-resistant properties.

Known materials using high friction aggregates on the surface to improve friction has been known. The surface applied aggregates provide good initial values, however as the surface is worn due to traffic, the skid resistance decreases. After surface layers containing anti-skid materials become worn out these aggregate materials loose their effectiveness and become slippery because they do not contain high friction particles (of sufficient size to provide good skid properties) in the intermix.

Current thermoplastics include small particulate aggregate to improve the skid-resistant properties of the markers. However, over time, it has been shown that when such particulates are too small, they become worn too quickly and thus do not provide sufficient skid-resistance for high traffic areas. Today's thermoplastic materials do not include properties of long-term skid resistance with long-term retroreflectivity.

A review of these issues demonstrates the need for thermoplastic products that maintains high RL while also providing high skid resistance once the marking product has been installed on the road surface

### DESCRIPTION OF RELEVANT ART

U.S. Pat. No. 3,958,891 to Eigenmann, Ludwig, and not assigned, describes an aggregate for securing in a layer of material which is used to form a traffic-regulating indicium, so as to improve the nighttime visibility characteristics and anti-skid characteristics of the traffic-regulating indicium. The aggregate comprises a core body surrounded at least partially by a mass of shock-absorbent binder substance and a plurality of elements that improve either nighttime visibility or anti-skid properties, or both. The elements are arranged in and bound by the binder substance such that the latter substantially fills the interspaces between at least the majority of adjacent pairs of the aforementioned elements, some of which being arranged adjacent to an external surface of the mass so as to impart a roughened texture to the external surface, thereby permitting the aggregate to be firmly secured in the traffic-regulating indicium. The remainder of the elements are distributed among different levels interiorly of the mass so that progressive wear of the aggregate and concomitant detachment of elements from the aggregate causes exposure of others of the elements, thereby conveying long-term durability to the traffic-regulating indicium.

U.S. Pat. No. 4,020,211 to Eigermann, Luwig and not assigned describes a new material adapted to be laid down and adhesively secured on a road surface to provide a traffic regulating sign with the material which has an upper surface exposed to traffic and provided with a plurality of sharp tips projecting above the surface for imparting good non-skid properties thereto, the new material comprising an upper layer adjacent to the upper surface, at least partially embedding hard particles to form sharp tips and consists of a polymeric resin having a high molecular cohesion such as a polyamide resin, a polyurethane resin or a polyterephthalic resin, thereby adding improved wear resistance properties to non-skid and high visibility properties.

U.S. Pat. No. 5,077,117 to Harper, et al., describes a pavement marking material comprising a flexible base sheet that is conformable to an irregular pavement surface. A durable, wear-resistant, polymeric top layer is adhered to one surface of the base sheet. The top layer is capable of undergoing brittle fracture at a temperature from 0 degrees Centigrade to 45 degrees Centigrade such that when the base sheet conforms to an irregular surface the top layer readily forms ruptures to relieve stress build-up in the top layer as the regions of the top layer defined by the ruptures remain adhered to and follow the conformance of the base sheet. A plurality of particles are embedded in and protrude from the top layer. The particles comprise retroreflective beads and skid-resistant granules. In a preferred embodiment, the top layer is characterized by a Young's modulus of from about 50,000 psi to about 300,000 psi, and a percent elongation at break of from about 4% to about 35%.

U.S. Pat. No. 6,217,252 to Tolliver, Howard R, et. al., and assigned to 3M, describes a method for marking a transportation surface in which the surface is heated to a temperature above the ambient temperature and a finely-divided, free flowing, flame-sprayable, powder binder material selected from the group consisting of acrylic polymers and copolymers, olefin polymers and copolymers having a number average molecular weight greater than 10,000, urethane polymers and copolymers, curable epoxy resins, ester polymers and copolymers, and blends thereof is melted or substantially softened. The molten or softened binder is then applied to the surface with a particulate topcoat or particulate filler selected from the group consisting of reflective elements; skid-resistant particles, magnetizable particles and mixtures thereof, and finally the applied materials are allowed to cool to form a marker in which the binder adheres directly to the surface.

U.S. Pat. No. 3,935,365 to Eigenmann, Ludwig, and not assigned, describes a tape material for securement to primer layers provided on roadway pavements so as to form traffic-regulating indicia on the latter. The tape material comprises a first layer that contains a polymeric binder having high molecular cohesion and one surface adapted to face towards a roadway pavement and another surface adapted to be exposed to traffic, a plurality of hard particles having a minimum of about 6 on the Mohs' Hardness Scale, some of which should have a sharp tip, distributed among various levels of the aforementioned first layer, and a second layer adapted to be secured to a primer layer on the roadway pavement bonded to one surface of the first layer. The second layer is compatible with the first layer so that a firm bond is formed between them. It is also compatible with the primer layer so that a bond forms between them when the tape material is placed on the primer layer. This tape material imparts good anti-ski properties to a traffic-regulating indicium formed therewith due to the presence of the tips of the hard particles, which provide gripping areas when exposed. It is also an effective skid-resister during wear of the traffic-regulating indicium due to the distribution of the hard particles among various levels of the first layer, which enables fresh hard particles to become exposed as hard particles next to the latter are removed by wear.

U.S. Pat. No. 5,053,253 to Haenggi, Robert, et al., and assigned to Minnesota Mining and Manufacturing Company, describes a method of producing skid-resistant substrate marking sheet in which a base sheet is provided and an upward face of the base sheet is coated with a liquid bonding material. A plurality of ceramic skid-resistant spheroids is embedded in the liquid bonding material, wherein the ceramic spheroids are characterized by having rounded surfaces and no substantial points and characterized by Krumbein roundness of at least 0.8. The liquid bonding material is then cured to a solid adherent polymeric matrix coating with the ceramic skid-resistant spheroids partially embedded, wherein the spheroids comprise a fired ceramic made from various raw materials.

U.S. Pat. No. 5,094,902 to Haenggi, Robert, et al., and assigned to Minnesota Mining and Manufacturing Company, describes a skid-resistant, surface marking material, comprising a polymer matrix phase having a top surface and a plurality of opaque, skid-resistant ceramic spheroids partially embedded in and protruding from the top surface of the polymer matrix phase, wherein said ceramic spheroids have rounded surfaces and no substantial points, and wherein said ceramic spheroids have a Krumbein roundness of at least 0.8.

U.S. Pat. No. 6,679,650 to Britt, Jerry, et al., and assigned to Ennis Paint Incorporated, describes a marked pavement system comprising a pavement surface, a first marking stripe adhered to the top of the pavement surface with a thickness of at least about 40 mils to about 110 mils and comprised of a solidified thermoplastic resin composition with a black pigment, and a second marking stripe adhered to the surface of the first marking stripe with a thickness of at least 40 mils to 750 mils. The second marking stripe should be narrower than the first marking stripe and comprised of a solidified thermoplastic resin composition with a pigment that visibly contrasts with the first marking stripe, wherein the marked pavement system is highly visible during the daylight hours and during periods of rain.

U.S. Pat. No. 6,790,880 to Purgett, Mark, et al., and assigned to 3M, describes a pavement marking comprising a binder having polyurea groups, wherein the binder is prepared from a coating composition comprising one or more aliphatic secondary amines, one or more polyisocynanates, and at least about 15 weight percent non-soluble material based on the weight of the final dried coating, and reflective elements. The patent also discloses the pavement marking wherein the binder is a sprayable, two-part coating composition.

U.S. Pat. No. 6,217,254 to Wallgren et al, and assigned to Flint Trading, Inc. of North Carolina, (original assignee Cleanosol AB, of Sweden) provides for a road marking comprising reflective material disposed on a first portion and a friction material disposed on a second portion of a fixed road marking. These portions can be shaped, to include strips. The main features of this disclosure are that there are separate portions (sections) of reflective and skid material, shaped portions (preferably strips or patches of variable shapes). Application is described as a two-step process and there is no mention of the bead specifics outside of mentioning the possibility of a large >0.7 mm bead to improve visibility in dark or wet conditions. The best properties achieved herein were a skid resistance of 55 SRT and a RL of 380, correlating to a skid resistance class of S3 and a RL class of R5 as determined by the newest edition of IS EN 1436.

U.S. Patent Application No. 2011/0059295 to Greer et al. and assigned to Flint Trading, Inc of Thomasville, N.C. (also herein the applicants) provides for a retroreflective pavement marking material composition comprising a base layer composition for application to a pavement substrate and a top layer comprising retroflective glass beads wherein the beads range in size from greater than 2 mm to about 5 mm, wherein the base layer and the top layer combine to form a single composite film. High index bead clusters are disclosed and are provided for with regular glass beads of 1.5 index of refraction (IOR) and a large diameter size.

3M™ Stamark™ High Performance Marking Tape A380SD is used an inlay for hot asphalt surfaces or an overlay pavement marking for asphalt and concrete surfaces in highway travel conditions of free-rolling traffic, and is used to mark lane lines, edge lines, channeling lines and gore markings Abrasion resistant ceramic beads and ceramic skid particles are applied in a patterned pile formation and the marking is applied using a pressure sensitive adhesive. As stated in the product bulletin, A380 SD fulfils the following classes of EN 1436 in new conditions relevant to this disclosure: R5 (≧300 mcd) and S3 (≧55 SRT). A non-warrantied, initial value of approximately 550 mcd/m²/lx is provided by 3M™ but is not a maintained Class S5 value as provided herein. In order to provide legends and symbols, an alternate product in the 3M™ series, L380SD, is recommended, where the disclosed thermoplastic pavement markings can provide lines, warnings, legends, road signage and other forms of road marking communications.

Great Britain Patent Application No. GB 2429978A to Aubree, Barry Mark, and assigned to Barry Mark Aubree, describes a method of producing a thermoplastic road-marking composition that comprises mixing an opaque pigment, a translucent particulate thermoplastic material and reflective glass beads such that when the thermoplastic material is subsequently melted to bind the composition and the composition is laid as a marking, the glass beads on the visible surface of the markings are not substantially obscured by the opaque pigment. The application also presents a thermoplastic road-marking composition comprising a mixture of a particulate filler material, a pigment, a translucent thermoplastic material and reflective glass beads wherein the pigment clings to the filler material and the reflective glass beads are generally clear of the pigment. Accordingly, the thermoplastic road-marking immediately has retroreflectivity without the requirement for an additional operation of adding glass beads to the surface of the marking and without the need to let the road-marking wear before it becomes retroreflective.

WIPO Patent Application No. WO03064771A1 to Hong, Le Hoa, et al., and assigned to Avery Dennison Corporation, describes a method for securing a preformed pavement marking construction with a top surface and at least one perimeter edge to pavement with a relatively flat roadway surface. The method includes adhering the preformed pavement marking construction the roadway surface, providing a curable structural adhesive, and applying the curable structural adhesive to the at least one perimeter edge such that the curable structural adhesive overlaps a portion of the top surface of the preformed pavement marking construction at its at least one perimeter edge and a portion of the roadway surface. Finally, the curable structural adhesive is cured to form a traffic-bearing top surface extending between the roadway surface and the preformed pavement marking construction.

The disclosed review of the relevant art indicates that a need still exists for a thermoplastic pavement marking method using an adhesive (sprayable or otherwise) that maintains the integrity of the pattern and a thermoplastic pavement marking composition that includes selected size bead/aggregate ratios for high skid resistance with a corresponding high retro-reflective luminance (RL) or retroreflectivity.

### SUMMARY OF THE INVENTION

The present disclosure describes a preformed thermoplastic pavement marking or hot melt applied material with high Class S5 skid resistance and high RL of Class R5 once the pavement marking has been adhered to road surfaces or other solid substrates. The need exists to produce preformed thermoplastic pavement marking materials with both high skid resistance and high RL, as the use of higher quantities of drop-on glass beads increases the product RL yet lowers the skid-resistance while a gain in skid-resistance shows a decline in RL, making a simultaneous achievement of these high performance characteristics previously unattainable. The uniqueness of the present invention lies in maintaining homogeneous bead-aggregate compositions throughout the entire preform or hot melt composition including the surface and the body, thereby providing longevity to both reflectivity and skid resistance without sacrificing any other physical or physio-chemical properties.

The preformed thermoplastic material of the present invention is comprised of about 20% binder and 80% “intermix”, where the intermix includes non-organics such as silica, calcium, and other inorganic pigments as well as high friction aggregate capable of passing through sieves sizes of about 10 to about 24 together with large beads. The surface applied anti-skid materials provide high initial friction properties, while large size aggregate and large beads in the intermix provide long term skid resistance and improve initial friction properties by creating an appropriately textured surface.

To achieve the desired traction and friction properties it should be recognized that there is a difference between slip resistance, which relates to traffic traveling over the pavement markers at a slow speed and to pedestrian traffic traveling over the same pavement marker surfaces and related to the static COF (coefficient of friction). Skid resistance relates, however to traffic traveling over the pavement markers at high speed, and depends on surface texture. Skid resistance is more applicable to the type of vehicular traffic.

Most specifically, the preformed or hot applied thermoplastic marking composition comprises a planar top surface portion and a planar bottom surface portion that are coplanar to each other, wherein the bottom surface portion is directly applied to a substrate via application of heat or pressure or both heat and pressure and wherein the top surface portion comprises both an intermix with retroreflective beads and aggregate that exists and is uniform throughout the thermoplastic composition and a surface drop on composition also comprising retroreflective beads and aggregate wherein the size ratio of said beads to the aggregate is 0.85:1.50 and the weight ratio of the beads to the aggregate is 0.80:1.60 and/or a surface area coverage at range of ratios of beads to aggregate of between 2.8:1 to 0.7, thereby maintaining uniformity both on the surface and within a body of the thermoplastic marking composition thus providing retroreflectivity of greater than or equal to 300 mcd and improving long-term skid resistance as measured by an SRV of greater than or equal to 65.

### DESCRIPTION

Common test methods for measuring the effectiveness of these pavement markers for slip and skid resistance include ASTM E303, entitled “Standard Test Method for Measuring Surface Frictional Properties Using the British Pendulum Tester”, which is the most commonly used test methodology. The British Pendulum Tester (BPT) is one of the most widely used instruments in the measurement of friction characteristics of pavement surfaces, Skid Resistant Values (SRV) are determined by the BPT. SRV values from the BPT can also be reported as the British Pendulum Number (BPN) or the Pendulum Test Value (PTV), and the BPT referred to as the Skid Resistance Test (SRT).

European Standard IS EN 1436 is a specification that concentrates on driver need and governs the required quality of the road marking and performance characteristics of white and yellow markings based on luminance, day- and night-time visibility, wet-night visibility and skid-resistance in combination with durability. IS EN 1436 has specified for roads with extensive traffic an RL of Class R5 of at least 300 mcd/m2/lx and a skid resistance of Class S5 of 65 SRV (BPN) as shown for white road markings in Table 1. Yellow marking specifying criteria are provided in Table 2.

TABLE 1
Criteria for White Road Markings (IS EN 1436)

| Retro- | | Retro- | | | | | |
|---|---|---|---|---|---|---|---|
| reflection (dry) | | reflection (wet) | | Luminance | | Skid Resistance | |
| Class | Value | Class | Value | Class | Value | Class | Value |
| R0 | NIL | RW | NIL | B0 | NIL | S0 | NIL |
| R2 | 100 mcd | RW1 | 25 mcd | B2 | 30 | S1 | 45 SRV |
| R4 | 200 mcd | RW2 | 35 mcd | B3 | 40 | S2 | 50 SRV |
| R5 | 300 mcd | RW3 | 50 mcd | B4 | 50 | S3 | 55 SRV |
| | | | | B5 | 60 | S4 | 60 SRV |
| | | | | | | S5 | 65 SRV |

TABLE 2
Criteria for Yellow Road Markings (IS EN 1436)

| Retro- | | Retro- | | | | | |
|---|---|---|---|---|---|---|---|
| reflection (dry) | | reflection (wet) | | Luminance | | Skid Resistance | |
| Class | Value | Class | Value | Class | Value | Class | Value |
| R0 | NIL | RW | NIL | B0 | NIL | S0 | NIL |
| R1 | 80 mcd | RW1 | 25 mcd | B1 | 20 | S1 | 45 SRV |
| R3 | 150 mcd | RW2 | 35 mcd | B2 | 30 | S2 | 50 SRV |
| R4 | 200 mcd | RW3 | 50 mcd | B3 | 40 | S3 | 55 SRV |
| | | | | | | S4 | 60 SRV |
| | | | | | | S5 | 65 SRV |

Road surfaces made from concrete or asphalt have SRT values in the range of 65 to 75, and a similar skid resistance of the pavement marking and road surface is beneficial to increasing driving safety at high speeds necessitating the need for a Class S5 skid resistance of the applied thermoplastic pavement marker.

Known materials have achieved only a combination of Class R5-S3 levels, as provided by 3M Stamark™ High Performance Pavement Marking Tape A380 and by Wallgren in U.S. Pat. No. 6,217,254. The new composition of the present disclosure provides a combination of the highest performance classes, generating R5-S5 classification results.

The required materials for the present invention to achieve both the necessary high retroreflectivity of Class R5 and equally high skid resistance of Class S5, as provided in IS EN 1436 entitled “Road Marking Materials—Performance for Road Users”, are those that contain a size ratio of bead to aggregate of 0.85:1.50, a weight ratio of bead to aggregate of 0.80:1.60 or a surface area coverage at range of ratios of beads to aggregate between 2.8:1 to 0.7:1.

The high friction large aggregates are included in the intermix with a weight percent content of up to 45% and the percent of beads are at about 30%. The optimal size of the large aggregates to be selected from are about 12 to about 20 grit (about 0.8 to about 1.7 millimeters depending on size of the large beads used). The present invention also includes the use of normally surface applied large aggregate in a range from about 14 to about 20 grit (about 0.8 mm to about 1.4 mm). Product using small particle aggregate sizes (approximately 24 grit or less) covered the surface area of the thermoplastic marking sheets more effectively; however, these aggregates did not provide the required skid resistant classification.

It has also been shown that it is possible to use single grit size aggregate in the intermix. The use of an intermix of different grit sized aggregates in different proportions based on the need for the future use of different materials (larger sizes for thicker and larger thermoplastic sheets and smaller aggregates for narrow strips) is also part of the present disclosure.

The aggregates used are angular particles primarily exhibiting a Mohs hardness of greater than 7, including corundum, quartz, calcined bauxite, and others (trade names of such materials include Mulcoa grade 60, AlphaStar®, Ultrablast®, and Alodur® which provide hardness ratings in the range of 7 to 9). A portion of the intermix used with the thermoplastic road marking includes 16 grit size aggregate also with a hardness in the Mohs scale reading of greater than 6. This combination has never been tried before in preformed or hot melt applied thermoplastic surface applications, and has resulted in improved friction.

Regular soda-lime glass, with a refractive index at about 1.5 and a larger than 1 mm average diameter, is the bead of choice for this application. Glass beads with gradation according to AASHTO M247-11 are provided as follows:
Type 3 (T3) glass beads provide 70% of the beads with a diameter in the range of 1.0-1.18 mm and 95% having diameter >0.85 mm.; overall weighted average diameter 1.05 mm
Type 4 (T4) glass beads provide 70% of the beads with a diameter in the range of 1.18-1.4 mm and 95% having diameter >1.0 mm.; overall weighted average diameter 1.25 mm
Type 5 (T5) glass beads provide 70% of the beads with a diameter in the range of 1.4-1.7 mm and 95% having diameter >1.18 mm.; overall weighted average diameter 1.4 mm

The aggregate particle size is to be selected as having an average of 70% to 120% of the glass bead diameter used. Aggregate particle size is defined and described per ANSI/ASTM E-11-81. In order to achieve this required property, the following must be maintained for the selected glass bead type:
T3 glass bead diameter 1.0-1.18 mm, aggregate 0.71 to 1.18 diameter (mesh size (grit) 24 to 18)
T4 glass bead diameter 1.18-1.4 mm, aggregate 0.85 to 1.4 diameter (mesh size (grit) 20 to 14)
T5 glass bead diameter 1.4-1.7 mm, aggregate 1.0 to 1.7 diameter (mesh size (grit) 18 to 12)

An additional desired result is improved overall skid resistance of the preformed thermoplastic markers without any associated loss of retroreflective luminance.

The aforestated special aggregates also improve the coefficient of sliding friction (COF) as determined per the ASTM E274 test. As the COF decreases below a certain level on the surrounding asphalt, a small wheel grabs onto the asphalt and if the COF is reduced on the pavement marking too much, undesirable skidding will occur. It is desirable that the COF of the preformed or hot melt thermoplastic match or be greater than the road pavement surface. The COF, in this case, as measured per ASTM E274 requires using a small cart pulled behind a car with a wheel attached to the bottom of the cart that rides at the speed of the car, thus touching the pavement surface, which eventually results in locking the wheel, thereby allowing for measurement of the force of the cart on the surface.

Therefore, a surprising result found during the course of experimentation and resulting in an important embodiment of the present application is that these thermoplastic marking surfaces maintain high RL of Class R5 and possess high skid resistance of Class S5, while marking surfaces without the special bead/aggregate combination described above have not achieved such classifications. In all previously known compositions, high values of retroreflectivity

A further embodiment of this disclosure is the achievement of these bead/aggregate combination thermoplastic marking surfaces maintaining R5-S5 classification without the use of special high refractive index glass beads, domes, or ceramic clusters, providing a more economical formulation. The refractive index of the selected regular glass bead is RI=1.5. It has been possible to achieve a high RL by using a high index glass bead; however, this type of glass bead selection has proven to not be durable.

There is also a strong need in the industry to provide a layer of preformed thermoplastic so that these marking surfaces are skid resistant and can be used for any crosswalk material. There is also a requirement that the skid resistance provides no compromise in retroreflectivity value (RL). The combination of “large” beads and hard aggregate using the defined ideal ratios with respect to the size and weight of beads to aggregate (such as corundum) using primarily a homogeneously mixed material, has not been previously accomplished.

An additional embodiment and surprising result is that in the past, without the use of these specific aggregate/bead combinations, the RL is compromised in the optimization of skid-resistance where the thermoplastic pavement marking materials with RL exceeding 400 mcd/m²/lx, do not usually achieve a BPN value exceeding 40-45 (or Class S1). In the case of the present disclosure, this is not true and this undesirable result has been eliminated.

In the present invention, the use of uniform particulate material or blends of particulate materials for the aggregate with differing hardness values, providing more economical solutions, can be introduced into the intermix during formulation. The introduction of these blends usually occurs prior to extrusion and completion of the thermoplastic pavement marking. The aggregates and other particles such as glass beads and the inorganic choices stated above can also, however, be dropped on the hot material during installation and completely embedded into body of the thermoplastic marking material in that fashion. The preformed thermoplastic surface marking product can be applied using pressure sensitive adhesives as well as by flame torching.

Another object of the present invention is to provide for long term skid resistance and maintained retroreflective luminance through the addition of Type 3-Type 5 glass beads in selective combination with certain sized aggregate particles. More specifically, the ratios to be maintained to maintain high R_{L} and adequate skid resistance requires surface bead sizes between T3 and T5 using 16-20 mesh or grit size (here the words mesh size and grit size are used interchangeably) corundum. The corresponding intermix requires bead sizes of between T3 and T5 with 12-20 mesh or grit sized aggregate. The ideal ratios are therefore as follows:

0.85:1.5 for the size ratio of beads:aggregate; and
0.6-1.6 for the weight ratio of beads:aggregate.

In previous intermix compositions, which do not cover the present disclosure, intermix beads are comparatively very small with the drop on beads—which are comparatively much larger. This combination is unacceptable when trying to combine high retroreflectivity with improved skid resistance for performed thermoplastic or hot melt road markers—in all these cases the skid resistance decreases and with increased retroreflectivity.

As stated above, the present invention includes larger grit size aggregate than is normally used in similar preformed thermoplastic pavement marking products. Specifically, the aggregate should be between 12 and 20 mesh (grit) in size, depending on the size glass bead selected, and may be comprised of quartz, corundum, crushed gravel, crushed granite, or any combination thereof. The aggregate used may also measure 7 or greater on the Mohs Hardness Scale. This selection of grit size improves the skid resistance properties of the pavement marker in combination with the corresponding size of glass bead selection and ensures that the product wears down more slowly, conveying greater durability and also longer term skid resistance—often through the end-of-life of the applied preformed thermoplastic.

Other advantages achieved using these working examples include the fact that when the surface applied aggregate provides high initial skid resistance using aggregate in the intermix, the surface maintains high skid properties during the entire period of use of the pavement markings and also provides increasing skid resistance. The drop on beads mixed together with aggregate provide an intermix so that the product maintains high RL and skid resistance during markings lifespan.

It should be understood that although examples are given it should not be construed that these are examples provide the only examples of the invention and that variations of the present invention are possible, while adhering to the inventive concept herein disclosed.

### WORKING AND COMPARATIVE EXAMPLES

### Test Methodology

European Standard IS EN 1436 specifies that for roads with extensive traffic a RL class of R5 of at least 300 mcd/m²/lx and a skid resistance class of S5 of at least 65 SRT (BPN) is required. Retroreflectivity of the applied material was tested using retroreflectometer Delta LTL-X Friction properties were tested according to ASTM E303.

### Working Example 1

An example of the hydrocarbon resin composition for the preformed thermoplastic of the present invention is provided as follows:

### Material Composition

| Binder: | |
|---|---|
| Escorez 7720 - | 8% |
| C5 hydrocarbon resin - | 7% |
| Escorene EVA MV 02514 | 3.2% |
| Refined mineral oil - | 1.8% |
| Fumed silica - | 0.3% |
| Titanium dioxide (Rutile) - | 10% |
| Fillers | |
| Glass beads Type 3 - | 30% |
| Corundum Grit 20 | 20% |
| CaCO3 - | 19.7% |

The material composition has a softening temperature (Ring and Ball) of 112° C. measured according to ASTM D36-06 entitled “Standard Test Method for Softening Point of Bitumen (Ring-and-Ball Apparatus)”.

The thermoplastic material composition was extruded using a casting die to create 125 mil thick preformed thermoplastic sheets. As the sheets were extruded glass beads T3 were dropped onto the melted thermoplastic material. Subsequently at a location further from the die exit on the manufacturing line, corundum grit 16 was added to the thermoplastic and indented visual heating indicators were applied to the surface.

| | | | Weight Ratio | Size Ratio |
|---|---|---|---|---|
| Composition | | | Beads:Aggre- | Beads:Aggre- |
| Type | Beads | Aggregate | gate | gate |
| Intermix, | T3 | Corundum, | | |
| Weight | | Grit 20 | | |
| percent | 30% | 20% | 1.5:1.0 | 1.22:1.0 |
| Surface | T3 | Corundum | | |
| Drop-on, | | Grit 16 | | |
| Lbs./sq/ft | 0.106 | 0.068 | 1.56:1.0 | 0.88:1.0 |

Surface area cover ratio (bead:aggregate) = 2.39:1.0

Using a Flint-2000 propane torch, the material composition was applied on asphalt and tested using Delta LTL-X retroreflectometer and British Pendulum tester and had the following properties:

initial retroreflectivity R_{L}, 344 mcd/m2/lx
skid resistance 65 BPN.

### Working Example 2

An example of alkyd based preformed thermoplastic of the present invention is provided as follows:

### Material Composition

| | |
|---|---|
| Polyamide Unirez 2633 | 7.8% |
| Hard resin Sylvacote 7021 | 8.5% |
| Plasticizer DINP | 3% |
| Polyethylene Wax | 2% |
| Fumed silica | 0.4% |
| Titanium dioxide | 10% |
| Glass beads T4 | 29% |
| Corundum Grit 16 | 24% |
| CaCO3 | 15.3% |

The material composition has a softening temperature (Ring and Ball) of 118° C. measured according to ASTM D36-06 entitled “Standard Test Method for Softening Point of Bitumen (Ring-and-Ball Apparatus)”.

The thermoplastic material composition was extruded using a casting die to create 90 mil thick preformed thermoplastic sheets. As the sheets were extruded glass beads T4 were dropped onto the melted thermoplastic material. Subsequently at a location further from the die exit on the manufacturing line, corundum grit 20 was added to the thermoplastic and indented visual heating indicators were applied to the surface.

| | | | Weight Ratio | Size Ratio |
|---|---|---|---|---|
| Composition | | | Beads:Aggre- | Beads:Aggre- |
| Type | Beads | Aggregate | gate | gate |
| Intermix, | T4 | Corundum, | | |
| Weight | | Grit 16 | | |
| percent | 29% | 24% | 1.21:1.0 | 1.04:1.0 |
| Surface | T4 | Corundum | | |
| Drop-on, | | Grit 20 | | |
| Lbs./sq/ft | 0.112 | 0.090 | 1.24:1.0 | 1.45:1.0 |

Surface area cover ratio (bead:aggregate) = 2.22:1.0

Using a Flint-2000 propane torch, the material composition was applied on asphalt at a test deck located on Holden Rd. in Greensboro, N.C. with average daily traffic (ADT) of 6500 per direction. Material was tested using a Delta LTL-X retroreflectometer and a British Pendulum tester and exhibited the following properties:

### Initial Properties:

RL=425 mcd/m²/lx; BPN=71

| | |
|---|---|
| After two months | RL = 480 mcd/m2/lx, BPN = 75 |
| After 12 month | RL = 350 mcd/m2/lx; BPN = 66 |
| After 20 moths | RL = 320 mcd/m2/lx; BPN = 70 |

### Working Example 3

Another example of a bead/aggregate drop-on for the preformed thermoplastic of the present invention is provided as follows:

### Material Composition for Working Example 3

| Binder composition | |
|---|---|
| Polyamide resin Uni-Rez 2633 | 7.8% |
| Modified rosin resin Sylvacote 4984 - | 7.1% |
| Phthalate plasticizer - | 2.3% |
| PE based wax - | 1.6% |
| TiO2 - | 10% |
| Fillers | |
| Glass beads T5 | 25% |
| Corundum grit 14 | 30% |
| CaCO3 - | 16.2% |

### Drop-On:

Bead: T5 at 0.102 lb/ft²

Aggregate: Corundum grit 20 at 0.112 lb/ft²

| | | | Weight Ratio | Size Ratio |
|---|---|---|---|---|
| Composition | | | Beads:Aggre- | Beads:Aggre- |
| Type | Beads | Aggregate | gate | gate |
| Intermix, | T5 | Quartz, | | |
| Weight | | Grit 14 | | |
| percent | 25% | 30% | 0.83:1.0 | 0.98:1.0 |
| Surface | T5 | Corundum | | |
| Drop-on, | | grit 16 | | |
| Lbs./sq/ft | 0.102 | 0.155 | 0.66:1.0 | 1.16:1.0 |

Surface area cover ratio (bead:aggregate) = 0.7:1.0

Material was extruded, applied and tested similar to the Example 2

Properties: RL=376 mcd/m²/lx
BPN=69

### Working Example 4

An additional example of a bead/aggregate drop-on for the preformed thermoplastic of the present invention is provided as follows:

### Material Composition for Working Example 4

| Binder composition | |
|---|---|
| Polyamide resin Uni-Rez 2633 | 8% |
| Modified rosin resin Sylvacote 4984 - | 7.5% |
| Phthalate plasticizer - | 2.0% |
| PE based wax - | 2.0% |
| TiO2 - | 10% |
| Fillers | |
| Glass beads T3 | 30% |
| Corundum grit 20 | 25% |
| CaCO3 - | 15.5% |

Material was extruded and applied on asphalt similar to the process described in the Example 2.

### Drop-On:

Bead: T4 at 0.092 lb/ft²
Aggregate: Corundum grit 20 at 0.094 lb/ft²

| | | | Weight Ratio | Size Ratio |
|---|---|---|---|---|
| Composition | | | Beads:Aggre- | Beads:Aggre- |
| Type | Beads | Aggregate | gate | gate |
| Intermix, | T3 | Corundum, | | |
| Weight | | Grit 20 | | |
| percent | 30% | 25% | 1.2:1.0 | 1.22:1.0 |
| Surface | T4 | Corundum, | | |
| Drop-on, | | Grit 20 | | |
| Lbs./sq/ft | 0.108 | 0.078 | 1.4:1.0 | 1.45:1.0 |

Surface area cover ratio (bead:aggregate) = 1.52:1.0

Properties: RL=444 mcd/m²/lx
BPN=73

While the many embodiments of the invention have been disclosed above, many other embodiments and variations are possible within the scope of the present disclosure and in the appended claims that follow. Accordingly, the details of the embodiments and examples provided are not to be construed as limiting. It is to be understood that the terms used herein are merely descriptive rather than limiting and that various changes and numerous equivalents may be made without departing from the spirit or scope of the invention as claimed.

We claim:

1. A preformed or hot applied thermoplastic marking composition comprising a planar top surface portion and a planar bottom surface portion that are coplanar to each other, wherein said bottom surface portion is directly applied to a substrate via application of heat or pressure or both heat and pressure and wherein said top surface portion comprises both an intermix with retroreflective beads and aggregate that exists and is uniform throughout said thermoplastic composition and a surface drop on composition also comprising retroreflective beads and aggregate wherein the size ratio of said beads to said aggregate is 0.85:1.50 and the weight ratio of said beads to said aggregate is 0.80:1.60 and/or a surface area coverage at range of ratios of beads to aggregate of between 2.8:1 to 0.7, thereby maintaining uniformity both on the surface and within a body of said thermoplastic marking composition thus providing retroreflectivity of greater than or equal to 300 mcd and improving long-term skid resistance as measured by an SRV of greater than or equal to 65.

2. The preformed or hot applied thermoplastic composition of claim 1, wherein said aggregate comprises corundum, quartz, granite, corundum, calcined clay, metal slag or any combination of said quartz, granite, corundum, calcined clay, or metal slag.

3. The preformed or hot applied thermoplastic composition of claim 1 wherein said thermoplastic marking composition is a sheathing, said sheathing comprising anti-skid resistance materials including said large grit size aggregate with and without retroreflective glass beads, wherein said aggregate and glass beads are either in said intermix or dropped onto said top surface portion before, during, or after application to a substrate.

4. The preformed or hot applied thermoplastic composition of claim 2, wherein said thermoplastic sheathing with said large grit size aggregate and with and without retroreflective glass beads are either in said intermix or dropped onto said top surface portion before, during, or after application to a substrate and wherein additional particles are dropped onto said top surface portion, wherein said particles are aggregates comprising corundum, crushed granite, crushed gravel, or quartz, or any combination of said corundum, and/or quartz.

5. The preformed or hot applied thermoplastic composition of claim 1 wherein said large grit size aggregate measures greater than 6 on the Mohs Hardness Scale

6. The preformed or hot applied thermoplastic composition of claim 1, wherein said bottom surface portion comprises an adhesive for bonding said bottom surface portion to any paved surface.

7. The preformed or hot applied thermoplastic composition of claim 1, wherein said top surface portion includes patterned markings, wherein said patterned markings are lines, legends, arrows, indicia, including colored surfaces and sections of said surfaces other than or together with a white color.

8. The adhesive of claim 6, wherein said adhesive is sprayable allowing for bridging said intersection on said planar bottom surfaces of said grid section and said insert section forming said unified pavement marking pattern and wherein said adhesive includes ethylene vinyl acetate (EVA) based hot melt or other equivalent hot melt polyamide resins.

9. The adhesive of claim 6, wherein said adhesive has a softening point in a range of 90 degrees centigrade to about 210 degrees centigrade and more preferably in a range of 90 degrees centigrade to about 120 degrees centigrade

10. The adhesive of claim 6, wherein said adhesive comprises a thermosetting adhesive.

11. The adhesive of claim 6, wherein said adhesive comprises a thermoplastic adhesive.

12. A preformed thermoplastic composition wherein said thermoplastic comprises an independent thermoplastic grid section, and an independent thermoplastic insert section, and wherein said insert section resides within said grid section and each said insert section is coplanar, and wherein said grid section and said insert section both comprise a planar top surface portion and a planar bottom surface portion that are coplanar to each other, such that said grid section is in direct contact with and adjacent to said insert section thereby forming an intersection between said grid section and said insert section, and further comprising an adhesive backing layer on said planar bottom surface, said adhesive backing layer bridging and bonding said planar bottom surface-to form a unified pavement marking pattern thereby preventing dislodging or separation of said pavement marking pattern during handling, movement, transportation before application of said pre-bonded pavement marking to the top of a pavement surface by application of heat or pressure or both heat and pressure, and further comprising both an intermix with aggregate that exists throughout said thermoplastic composition and surface drop on retroreflective beads wherein the size ratio of said beads to said aggregate is 0.85:1.50 and the weight ratio of said beads to said aggregate is 0.80:1.60 and/or a surface area coverage at range of ratios of beads to aggregate of between 2.8:1 to 0.7:1, thereby maintaining a retroreflectivity of greater than or equal to 300 mcd and improving long-term skid resistance as measured by an SRV of greater than or equal to 65.

13. The preformed thermoplastic of claim 12, comprising said grid and a plurality of inserts, each of said inserts separated by said grid.

14. A method of making a preformed or hot applied thermoplastic marking composition comprising a planar top surface portion and a planar bottom surface portion that are coplanar to each other, wherein said bottom surface portion is directly being applied to a substrate via application of heat or pressure or both heat and pressure and wherein said top surface portion comprises an intermix that exits throughout said thermoplastic composition and wherein said top surface portion comprises both an intermix with aggregate that exists throughout said thermoplastic composition and surface drop on retroreflective beads wherein the size ratio of said beads to said aggregate is 0.85:1.50 and the weight ratio of said beads to said aggregate is 0.80:1.60 and/or a surface area coverage at range of ratios of beads to aggregate of between 2.8:1 to 0.7:1, thereby maintaining a retroreflectivity of greater than or equal to 300 mcd and improving long-term skid resistance as measured by an SRV of greater than or equal to 65.

15. The method of making the thermoplastic composition of claim 14, wherein said aggregate comprises quartz, granite, corundum, calcined clay, metal slag or any combination of said quartz, granite, corundum, calcined clay, or metal slag.

16. The method of making the thermoplastic composition of claim 14, wherein said thermoplastic marking composition is a sheathing, said sheathing comprising anti-skid resistance materials including said large grit size aggregate with and without retroreflective glass beads, wherein said aggregate and glass beads are either in said intermix or dropped onto said top surface portion before, during, or after application to a substrate.

17. The method of making the thermoplastic composition of claim 14, wherein said thermoplastic sheathing with said large grit size aggregate and with and without retroreflective glass beads are either in said intermix or dropped onto said top surface portion before, during, or after application to a substrate and wherein additional particles are dropped onto said top surface portion, wherein said particles are aggregates, glass beads, including type 1 and type 3 glass beads, as well as large grit size aggregate in the range of 8 to 20 mesh or grit size said aggregate comprising corundum, crushed granite, crushed gravel, or quartz, or any combination of said corundum, crushed granite, crushed gravel, and/or quartz.

18. The method of making the thermoplastic composition of claim 14, wherein said large grit size aggregate measures greater than 6 on the Mohs Hardness Scale

19. The method of making the thermoplastic composition of claim 14, wherein said aggregate provides a surface roughness measured using a calibrated friction number F60, across a yielding values of about 0.17 to about 0.40

20. The method of making the thermoplastic composition of claim 14, wherein said aggregate embedded within the surface of said top surface portion provides a surface roughness which is measured as a mean profile depth and wherein said mean profile depth is between about 0.35 to about 0.75 millimeters.

21. The method of making the thermoplastic composition of claim 14, wherein said bottom surface portion comprises an adhesive for bonding said bottom surface portion to any paved surface.

22. The method of making the thermoplastic composition of claim 14, wherein said top surface portion includes patterned markings, wherein said patterned markings are lines, legends, arrows, indicia, including colored surfaces and sections of said surfaces other than or together with a white color.

23. The adhesive of claim 22, wherein said adhesive is sprayable allowing for bridging said intersection on said planar bottom surfaces of said grid section and said insert section forming said unified pavement marking pattern and wherein said adhesive includes ethylene vinyl acetate (EVA) based hot melt or other equivalent hot melt polyamide resins.

24. The adhesive of claim 23, wherein said adhesive has a softening point in a range of 90 degrees centigrade to about 210 degrees centigrade and more preferably in a range of 90 degrees centigrade to about 120 degrees centigrade

25. The adhesive of claim 24, wherein said adhesive comprises a thermosetting adhesive.

26. The adhesive of claim 24, wherein said adhesive comprises a thermoplastic adhesive.

27. The method of making a thermoplastic composition wherein said thermoplastic comprises an independent thermoplastic grid section, and an independent thermoplastic insert section, and wherein said insert section resides within said grid section and each insert section is coplanar, and wherein said grid section and said insert section both comprise a planar top surface portion and a planar bottom surface portion that are coplanar to each other, such that said grid section is in direct contact with and adjacent to said insert section, thereby forming an intersection between said grid section and said insert section, and further comprising an adhesive backing layer on said planar bottom surface, said adhesive backing layer bridging and bonding said planar bottom surface to form a unified pavement marking pattern thereby preventing dislodging or separation of said pavement marking pattern during handling, movement, and/or transportation before application of said pre-bonded pavement marking to a top of a pavement surface by application of heat or pressure or both heat and pressure, and wherein said top surface portion comprises both an intermix with aggregate that exists throughout said thermoplastic composition and surface drop on retroreflective beads wherein the size ratio of said beads to said aggregate is 0.85:1.50 and the weight ratio of said beads to said aggregate is 0.80:1.60 and/or a surface area coverage with a range of ratios of beads to aggregate of between 2.8:1 to 0.7:1, thereby maintaining a retroreflectivity of greater than or equal to 300 mcd and improving long-term skid resistance as measured by an SRV of greater than or equal to 65.
